(19) United States
(12) Patent Application Publication
(10) Pub. No.: US 2026/0338127 A1
(43) Pub. Date: Oct. 29, 2026

(54) Methods And Systems For Operating An Internal Combustion Engine

(71) Applicant: Schaeffler Technologies AG & Co. KG, Herzogenaurach (DE)

(72) Inventors: Michael Nienhoff, Regensburg (DE); Paul Rodatz, Landshut (DE); Gerhard Haft, Maxhütte-Haidhof (DE); Fabian Fink, Reichenschwand (DE)

(73) Assignee: Schaeffler Technologies AG & Co. KG, Herzogenaurach (DE)

(21) Appl. No.: 19/119,712

(22) PCT Filed: Sep. 26, 2023
(86) PCT No.: PCT/EP2023/076493

§ 371 Date: Apr. 9, 2025

(30) Foreign Application Priority Data
Oct. 13, 2022 (DE) 10 2022 210 818.3

(51) Int. Cl. F02D 41/14

(52) U.S. Cl. CPC F02D 41/1475; F02D 41/1463; F02D 2041/1468

(57) ABSTRACT

The teachings herein include methods for operating an internal combustion engine having an exhaust gas system with a catalytic converter device to at least partially store oxygen and an exhaust gas sensor downstream from the catalytic converter device to generate an exhaust gas signal representing an exhaust gas value corresponding to a sum of nitrogen oxide content and ammonia content in the exhaust gas. An example includes: operating the internal combustion engine using a rich combustion gas mixture after a throttle cut-off phase of the internal combustion engine has taken place longer than a predetermined time threshold value; receiving an exhaust gas signal from the exhaust gas sensor; determining that the exhaust gas signal meets a predetermined target criterion; and operating the internal combustion engine using an essentially stoichiometric combustion gas mixture when it has been determined that the exhaust gas signal meets the predetermined target criterion.

### CROSS-REFERENCE TO RELATED APPLICATIONS

This application is a U.S. National Stage Application of International Application No. PCT/EP2023/076493 filed Sep. 26, 2023, which designates the United States of America, and claims priority to DE Application No. 10 2022 210 818.3 filed Oct. 13, 2022, the contents of which are hereby incorporated by reference in their entirety.

### TECHNICAL FIELD

The teachings of the present disclosure relate to internal combustion engines. Various embodiments include methods and/or systems for operating an internal combustion engine.

### BACKGROUND

No fuel is typically injected during the throttle cut-off phase of an internal combustion engine of a vehicle, in order to minimize the consumption and the untreated emissions of the internal combustion engine. The exhaust gas system is therefore flushed using air in this operating phase of the internal combustion engine. A catalytic converter device arranged in the exhaust gas system, such as a three-way catalytic converter which has an oxygen storage capacity, can store the oxygen contained in the air during this phase. If the throttle cut-off phase is sufficiently long, the complete catalytic converter device, which can consist of a catalytic converter close to the internal combustion engine and an underbody catalytic converter, is flushed with oxygen and nearly completely filled with oxygen.

If the injection begins again after the throttle cut-off phase, at least a part of the oxygen charge has to be expelled from the catalytic converter device or the catalytic converter device has to be at least partially reduced in order to be robust again against both a lean exhaust and a rich exhaust in the following operation. If a lean exhaust (=lambda >1) occurs, the nitrogen oxide emissions increase. In contrast thereto, increasing HC, CO, and NH3 emissions occur when too much fuel is injected, i.e. when a rich exhaust occurs (=lambda <1).

To be able to at least partially expel a part of the stored oxygen after the throttle cut-off phase, the internal combustion engine is operated briefly using a rich combustion gas mixture is known. Such operation is called catalytic converter clearing. During the catalytic converter clearing, carbon oxides (CO) and hydrocarbons (HC) which arise can be converted using the oxygen stored in the catalytic converter device to form carbon dioxide (CO2) and water (H2O). Undesired byproducts such as nitrogen oxides (NOx) and/or also ammonia (NH3) also arise in this case.

Since only a part of the oxygen stored in the catalytic converter device is to be expelled during the catalytic converter clearing, using the exceeding of a predetermined lambda voltage of a binary lambda probe arranged downstream from the catalytic converter device as a target criterion for terminating the catalytic converter clearing is known from the prior art. Furthermore, falling below a modeled oxygen loading threshold value in relation to a predetermined oxygen loading threshold value as a target criterion for terminating the catalytic converter clearing is known.

The exceeding of the predetermined lambda voltage can be too late and/or that the modeled oxygen loading value, which is compared to a predetermined oxygen loading threshold value, has been determined excessively inaccurately. Further methods and devices are known from US 2022/0178295 A1, JP 4 134 398 B2, US 9 765 715 B2, JP 2022-067790 A, JP 3 744 373 B2, DE 10 2021 202 965 A1, and DE 10 2021 209 107 B3.

### SUMMARY

Various embodiments of the present disclosure include methods and computer programs for operating an internal combustion engine, using which the catalytic converter clearing following a throttle cut-off phase can be terminated at an optimum time and it is possible to change to the normal operation of the internal combustion engine using an essentially stoichiometric combustion gas mixture. For example, some embodiments of the teachings herein include a method for operating an internal combustion engine (100) having an exhaust gas system (130), which includes at least one catalytic converter device (132), which is designed to at least partially store oxygen, and an exhaust gas sensor (134) arranged downstream from the at least one catalytic converter device (132), which is designed to generate an exhaust gas signal that specifies an exhaust gas value which indicates the sum of nitrogen oxide content and ammonia content in the exhaust gas, wherein the method comprises: actuating the internal combustion engine (100) such that it is operated using a rich combustion gas mixture after a throttle cut-off phase of the internal combustion engine (100) has taken place which is longer than a predetermined time threshold value, wherein the following takes place during the actuation of the internal combustion engine (100) using the rich combustion gas mixture: receiving at least one exhaust gas signal (206) of the exhaust gas sensor (134), and determining that the at least one exhaust gas signal (206) meets at least one predetermined target criterion, and actuating the internal combustion engine (100) such that it is operated using an essentially stoichiometric combustion gas mixture when it has been determined that the at least one exhaust gas signal (206) meets at least one predetermined target criterion.

In some embodiments, determining that the at least one exhaust gas signal (206) meets at least one predetermined target criterion comprises determining that the at least one received exhaust gas signal (206) indicates an exhaust gas value which exceeds a predetermined exhaust gas threshold value (C1).

In some embodiments, determining that the at least one exhaust gas signal (206) meets at least one predetermined target criterion furthermore comprises determining that the exhaust gas signal (206) has reached a local maximum (P2).

In some embodiments, determining that the at least one exhaust gas signal (206) meets at least one predetermined target criterion furthermore comprises: receiving at least one further exhaust gas signal (206) of the exhaust gas sensor (134) after the local maximum (P2) has been reached, and determining that the gradient (208) of the at least one further exhaust gas signal (206) has reached a predetermined gradient threshold value (S1, S2).

In some embodiments, the gradient threshold value (S1, S2) is negative or positive.

In some embodiments, the essentially stoichiometric combustion gas mixture has a lambda value between approximately 0.998 and 1.002.

In some embodiments, the rich combustion gas mixture has a lambda value of approximately 0.8.

In some embodiments, the predetermined time threshold value is between approximately 1 and 5 seconds.

As another example, some embodiments include a computer program which comprises commands which, when they are executed by a processor or control unit of a controller (110), cause the controller (110) to carry out one or more of the methods as described herein.

As another example, some embodiments include a computer-readable medium storing computer program as described herein.

As another example, some embodiments include a controller (110) for operating an internal combustion engine having an exhaust gas system (130), which includes at least one catalytic converter device (132), which is designed to at least partially store oxygen, and an exhaust gas sensor (134) arranged downstream from the at least one catalytic converter device (132), which is designed to generate an exhaust gas signal (206), which indicates an exhaust gas value that specifies the sum of nitrogen oxide content and ammonia content in the exhaust gas, wherein the controller (110) is designed to carry out one or more of the methods as described herein.

### BRIEF DESCRIPTION OF THE DRAWINGS

Further advantages and features of the teachings herein are apparent to a person skilled in the art by putting the teaching described herein into practice and taking into consideration the drawings, in which:

FIG. 1 shows a schematic representation of an internal combustion engine having an exhaust gas system, a catalytic converter device, and an exhaust gas sensor incorporating teachings of the present disclosure;

FIG. 2 shows an exemplary diagram of time curves of the nitrogen oxide content and ammonia content in the exhaust gas of the internal combustion engine of FIG. 1;

FIG. 3 shows the time curve of the curves of the nitrogen oxide content and ammonia content of the exhaust gas signal of the exhaust gas sensor of the internal combustion engine of FIG. 1 which are associated with FIG. 2;

FIG. 4 shows the time curve of the gradient of the exhaust gas of FIG. 3;

FIG. 5 shows the time curve of the curves of the nitrogen oxide content and ammonia content of the exhaust gas signal of the exhaust gas sensor of the internal combustion engine of FIG. 1 which are associated with FIG. 2;

FIG. 6 shows the time curve of the gradient of the exhaust gas signal of FIG. 5;

FIG. 7 shows the time curve of the curves of the nitrogen oxide content and ammonia content of the exhaust gas signal of the exhaust gas sensor of the internal combustion engine of FIG. 1 which are associated with FIG. 2;

FIG. 8 shows the time curve of the gradient of the exhaust gas signal of FIG. 7; and

FIG. 9 shows a flow chart of an example method incorporating teachings of the present disclosure for operating the internal combustion engine of FIG. 1.

### DETAILED DESCRIPTION

The teachings of the present disclosure include using the exhaust gas signal of an exhaust gas sensor arranged downstream from a catalytic converter device, in particular a three-way catalytic converter device, which indicates the sum of the nitrogen oxide content and ammonia content in the exhaust gas of an internal combustion engine, to detect the optimum time to terminate the so-called catalytic converter clearing, which follows a throttle cut-off operation of the internal combustion engine. In particular, the exhaust gas signal is evaluated during the operation of the internal combustion engine using a rich combustion gas mixture, which directly follows a sufficiently long throttle cut-off phase of the internal combustion engine, and it is studied whether at least one predetermined target criterion for terminating the catalytic converter clearing exists. The catalytic converter clearing phase can thus be regulated by evaluating the exhaust gas signals of the exhaust gas sensor. Furthermore, the catalytic converter clearing phase can be ended earlier based on the evaluation of the exhaust gas signals of the exhaust gas sensor in comparison to the evaluation of the signals of the lambda probe, which can result in lower emissions.

Some embodiments of the teachings herein include a method for operating an internal combustion engine having an exhaust gas system, which has at least one catalytic converter device designed to at least partially store oxygen, and an exhaust gas sensor arranged downstream from the at least one catalytic converter device designed to generate an exhaust gas signal indicating an exhaust gas value that specifies the sum of nitrogen oxide content and ammonia content in the exhaust gas. An example method comprises actuating the internal combustion engine such that it is operated using a rich combustion gas mixture after a throttle cut-off phase of the internal combustion engine has taken place which is longer than a predetermined time threshold value. During the actuation of the internal combustion engine using the rich combustion gas mixture, at least one exhaust gas signal of the exhaust gas sensor is received and it is determined that the at least one exhaust gas signal meets at least one predetermined target criterion. The method furthermore comprises actuating the internal combustion engine such that it is operated using an essentially stoichiometric combustion gas mixture when it has been determined that the at least one exhaust gas signal meets at least one predetermined target criterion.

Therefore, the exhaust gas signal of the exhaust gas sensor is evaluated as to whether at least one predetermined target criterion for switching the operation of the internal combustion engine using a rich combustion mixture to an operation of the internal combustion engine using an essentially stoichiometric combustion gas mixture is met and therefore the so-called catalytic converter clearing, which directly follows a throttle cut-off operation of the internal combustion engine existing for a sufficiently long time, can be terminated.

The catalytic converter device, which is completely loaded with oxygen during the throttle cut-off phase of the internal combustion engine, has now been sufficiently reduced so that a switch to normal operation using an essentially stoichiometric combustion gas mixture can take place. The fact is utilized here that during the operation of the internal combustion engine using rich combustion gas mixture (i.e. during the catalytic converter clearing), the oxygen loading of the catalytic converter device decreases and therefore the generation of ammonia in the catalytic converter device increases. During the catalytic converter clearing, initially an unavoidable nitrogen oxide peak occurs in the exhaust gas signal, which decreases with decreasing oxygen loading of the catalytic converter device.

As a result of the progressing reduction of the oxygen loading of the catalytic converter device due to the operation of the internal combustion engine using a rich combustion gas mixture, however, ammonia is generated in the catalytic converter device, which is shown by an ammonia peak in the exhaust gas signal chronologically following the nitrogen oxide peak. The corresponding exhaust gas signal of the exhaust gas sensor, which specifies s the sum of nitrogen oxide content and ammonia content in the exhaust gas, therefore initially indicates an increase of the nitrogen oxide content up to a maximum. The nitrogen oxide content in the exhaust gas then decreases again, which is shown by a decreasing exhaust gas signal of the exhaust gas sensor. The renewed increase of the exhaust gas signal of the exhaust gas sensor which follows after passing through a minimum is based in the ammonia generation due to the progressively reduced oxygen loading of the catalytic converter.

In some embodiments, determining that the at least one exhaust gas signal meets at least one predetermined target criterion includes determining that the at least one received exhaust gas signal indicates an exhaust gas value which exceeds a predetermined exhaust gas threshold value. Therefore, the catalytic converter clearing is terminated as soon as the at least one received exhaust gas signal exceeds the predetermined exhaust gas threshold value. This means that the unavoidable generation of nitrogen oxides at the beginning of the catalytic converter clearing can be used to end the catalytic converter clearing process. Depending on the engine operating point (exhaust gas temperature, exhaust gas mass flow, lambda value, etc.) and the embodiment of the catalytic converter device, such as size, noble metal loading, oxygen storage capacity, etc., an early termination of the catalytic converter clearing can be reasonable, since then rich exhaust gas mixture is still located in the exhaust gas system upstream from the catalytic converter device. A typical threshold value is approximately 100 ppm.

In some embodiments, determining that the at least one exhaust gas signal meets at least one predetermined target criterion furthermore comprises determining that the exhaust gas signal has reached a local maximum. The catalytic converter clearing is therefore terminated and the internal combustion engine is switched to the operation using an essentially stoichiometric combustion gas mixture as soon as the exhaust gas signal has reached a local maximum. The local maximum describes the status of the catalytic converter device in which the unavoidable nitrogen oxide peak in the exhaust gas signal of the exhaust gas sensor due to the oxygen loading has reached a maximum. The catalytic converter device begins here to increasingly convert the nitrogen oxides generated by the combustion or in the catalytic converter device.

In some embodiments, determining that the at least one exhaust gas signal has met at least one predetermined target criterion furthermore includes receiving at least one further exhaust gas signal of the exhaust gas sensor, according to which the local maximum has been reached, and determining that the gradient of the at least one received further exhaust gas signal has reached a predetermined gradient threshold value. After a local maximum is reached, the catalytic converter clearing can furthermore only be terminated when in addition the gradient of the at least one received further exhaust gas signal has reached the predetermined gradient threshold value. This is used to increase the robustness of the detection of a local maximum in the exhaust gas signal of the exhaust gas sensor and can also be used to define the optimum time of the termination of the catalytic converter clearing.

In some embodiments, the gradient threshold value is negative or positive. As a result, the gradient of the exhaust gas signal can also be evaluated in addition to the exhaust gas signal of the exhaust gas sensor, which indicates an exhaust gas value in the exhaust gas of the internal combustion engine. The gradient can be negatively decreasing here (decrease of the exhaust gas signal immediately after the nitrogen oxide maximum) or in the range between the local maximum of the nitrogen oxide content and the local maximum of the ammonia content, wherein a local minimum is located between these two local maxima. Moreover, further criteria, such as an oxygen integral since the gradient has fallen below an oxygen threshold value, can be used as a termination criterion in order to define an optimum time for the termination of the catalytic converter clearing.

The essentially stoichiometric combustion gas mixture may have a lambda value between approximately 0.998 and 1.002. In some embodiments, the rich combustion gas mixture has a lambda value of approximately 0.8.

In some embodiments, the predetermined time threshold value for detecting a throttle cut-off phase is approximately 1 to 5 seconds. In some embodiments, a sufficiently long throttle cut-off phase of the internal combustion engine can be established if the oxygen mass introduction into the catalytic converter device exceeds a predetermined oxygen mass threshold value. The oxygen mass introduction into the catalytic converter device can be detected by means of the linear lambda signal of the lambda probe arranged upstream from the catalytic converter device and/or estimated via a suitable model, which can additionally consider the exhaust gas mass flow.

Some embodiments include a computer program having commands which, when they are executed by a processor or control unit of a controller, prompt the controller to carry out one or more of the methods described herein for operating the internal combustion engine. In some embodiments, a computer-readable medium stores the computer program.

Some embodiments include a controller for operating an internal combustion engine having an exhaust gas system which includes at least one catalytic converter device designed to at least partially store oxygen, and an exhaust gas sensor arranged downstream from the at least one catalytic converter device, which is designed to generate an exhaust gas signal that indicates an exhaust gas value which specifies the sum of nitrogen oxide content and ammonia content in the exhaust gas. The controller according to the invention is designed here to carry out a method according to the invention for operating the internal combustion engine.

In the present disclosure, the term “catalytic converter clearing” describes a temporary operating mode of an internal combustion engine which follows a sufficiently long throttle cut-off phase of the internal combustion engine before the internal combustion engine changes to normal operation using an essentially stoichiometric combustion gas mixture. During the catalytic converter clearing, the internal combustion engine is operated using a rich combustion gas mixture in order to at least partially reduce the catalytic converter device, which is nearly completely filled with oxygen during the throttle cut-off phase of the internal combustion engine and therefore condition it for the normal operation of the internal combustion engine then following. In the present disclosure, the term “combustion gas mixture” describes a mixture made up of fuel and air, which is combusted in an internal combustion engine. A “rich combustion gas mixture” is distinguished by a combustion air ratio of lambda (also called air ratio or air number) less than 1. The lambda value describes the mass ratio of air to fuel relative to the respective stoichiometric ideal ratio for a theoretically complete combustion process. Furthermore, an essentially stoichiometric combustion gas mixture is characterized by a lambda value which is in a range from approximately 0.998 to 1.002.

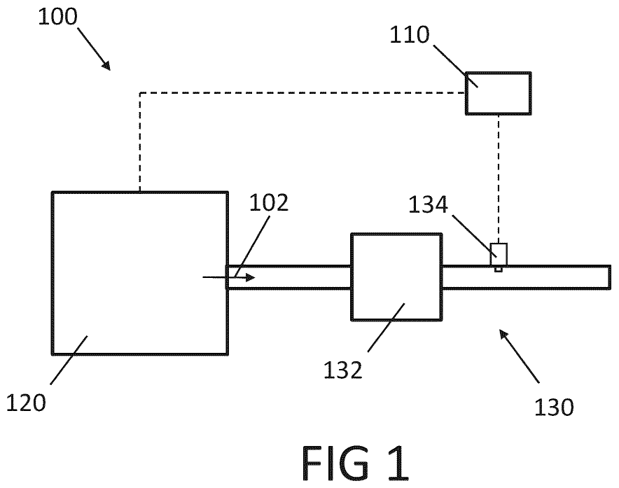

FIG. 1 shows a schematic representation of an example internal combustion engine 100 incorporating teachings of the present disclosure, the operation of which is controlled by a controller 110. In particular, the internal combustion engine 100 comprises a combustion section 120, which includes an air intake system (not explicitly shown) and at least one combustion chamber (also not explicitly shown), and an exhaust gas system 130 adjoining thereon downstream, in which a catalytic converter device 132 and an exhaust gas sensor 134 arranged downstream from the catalytic converter device 132 are arranged. The flow direction of the exhaust gas through the exhaust gas system 130 is indicated in FIG. 1 by the arrow 102.

The controller 110 can include hardware components and/or software components. Furthermore, the controller 110 includes a processor or control unit, which is designed to execute commands. In particular, the controller can contain at least one computer program designed to control the operation of the internal combustion engine 100.

In some embodiments, the exhaust gas system 130 can additionally include a further catalytic converter device arranged downstream from the exhaust gas sensor 134 and a further exhaust gas sensor arranged downstream from the further catalytic converter device.

The catalytic converter device 132 is a catalytic converter device designed to store oxygen. For example, the catalytic converter device 132 can be a three-way catalytic converter, a particle filter equipped with a catalytically active coating, a combination of three-way catalytic converter and uncoated particle filter, or a combination of three-way catalytic converter and coated particle filter. Furthermore, further three-way catalytic converters and/or particle filters can also be arranged downstream.

The exhaust gas sensor 134 generates an exhaust gas signal which specifies in exhaust gas value that indicates the sum of nitrogen oxide content and ammonia content in the exhaust gas. Therefore, the exhaust gas sensor can be, for example, a nitrogen oxide sensor based on the amperometric measurement principle, which is cross-sensitive to ammonia and therefore measures the sum of nitrogen oxide content and ammonia content in the exhaust gas.

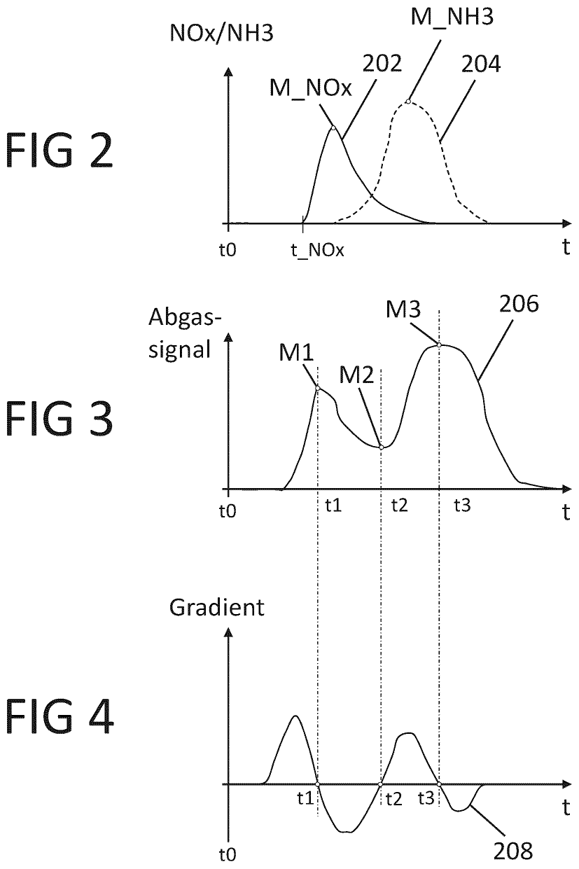

FIG. 2 shows an exemplary diagram of time curves of the nitrogen oxide content 202 and ammonia content 204 in the exhaust gas of the internal combustion engine of FIG. 1 at the position of the exhaust gas sensor 134 during a catalytic converter clearing phase of the internal combustion engine 100, which starts at the time t0. The exemplary curve 202 of the nitrogen oxide content in the exhaust gas of the internal combustion engine 100 includes a maximum M_NOx, before this is reduced to a value of approximately zero. The exemplary curve 204 of the ammonia content in the exhaust gas of the internal combustion engine 100 of FIG. 2 also has a maximum M_NH3, which is later in time than the maximum M_NOx of the curve 202 of the nitrogen oxide content, however.

The curves 202, 204 of FIG. 2 are based on the fact that during the catalytic converter clearing, the catalytic converter device 132 is initially reduced, i.e. the oxygen stored therein is removed by converting the injected fuel which is excessive in relation to the stoichiometric ratio (lambda <1). Since the catalytic converter device 132 is nearly completely loaded with oxygen after a cut-off phase, initially no nitrogen oxide conversion takes place (from the time t_NOx). With decreasing oxygen loading, the conversion efficiency of the nitrogen oxides of the catalytic converter device 132 increases more and more, so that a greater and greater part of the nitrogen oxides generated by the internal combustion engine 100 is converted. The result is the unavoidable nitrogen oxide peak shown in FIG. 2. The more strongly the oxygen in the catalytic converter device is removed, the better the conditions become for generating ammonia. With the aid of the carbon monoxide sufficiently present due to the rich combustion, hydrogen is increasingly formed by the water gas shift reaction in the catalytic converter device 132, due to which the nitrogen oxides can convert into ammonia. The second peak shown thus occurs, which results essentially due to the existing ammonia concentration, since the exhaust gas sensor 134 is cross-sensitive to ammonia and therefore detects the sum of nitrogen oxide concentration and ammonia concentration. The ammonia generation is ended with the termination of the catalytic converter clearing.

FIG. 3 shows the time curve 206 of the exhaust gas sensor 134, which correlates with the curves 202, 204 of the nitrogen oxide content and the ammonia content of FIG. 2. In particular, it is apparent from FIG. 3 that the exhaust gas signal 206 has two local maxima M1 and M3, namely the local maximum M1 at the time t1 and the local maximum M3 at the time t3. Furthermore, the curve 206 of the exhaust gas signal of the exhaust gas sensor 134 of FIG. 3 has a local minimum M2 at the time t2 arranged between the local maxima M1, M3. The curve 206 of the exhaust gas signal of FIG. 3 shows, as already mentioned, the sum signal of the two curves 202, 204 of the nitrogen oxide content and ammonia content of FIG. 2, because of which the curve 206 of the exhaust gas signal of the exhaust gas sensor is exclusively in the positive range.

FIG. 4 shows the time curve 208 of the gradient of the exhaust gas signal 206 of the exhaust gas sensor 134 of FIG. 3. Accordingly, the curve 208 of the gradient has a zero value at each of the times t1, t2, and t3, wherein the gradients pass through a sign change at these times due to the local maxima M1, M3 and the local minimum M2. The curve 208 of the gradient of the exhaust gas signal 206 of the exhaust gas sensor 134 is the mathematical derivative of the exhaust gas signal 206 according to the time t.

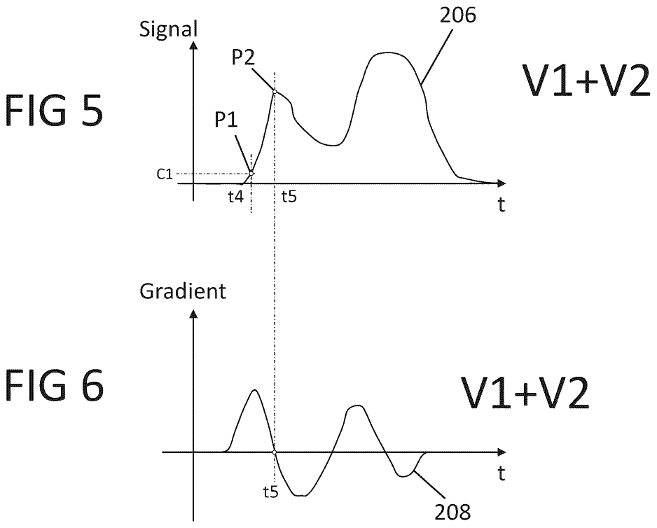

A first example embodiment of a method for operating the internal combustion engine 100 is explained hereinafter with reference to FIG. 5, in particular the time at which the catalytic converter clearing can be ended. For this purpose, FIG. 5 once again shows the exemplary time curve 206 of the exhaust gas signal of the exhaust gas sensor 134 of the internal combustion engine 100 of FIG. 3.

The catalytic converter clearing can be ended when the exhaust gas signal 206 of the exhaust gas sensor 134 reaches a predetermined exhaust gas threshold value C1. This is shown in FIG. 5 by means of the point P1. FIG. 5 shows that at the time t4, the exhaust gas signal 206 of the exhaust gas sensor 134 reaches and exceeds the predetermined exhaust gas threshold value C1 (for example approximately 100 ppm). This means that the exhaust gas signal increases and the unavoidable nitrogen oxide peak occurs. If this is determined, at this time t4, the operation of the internal combustion engine 100 using the rich combustion mixture, i.e. the catalytic converter clearing, can be ended and the internal combustion engine 100 can be switched to a normal operation using an essentially stoichiometric combustion gas mixture.

In some embodiments, the catalytic converter clearing can be ended when the exhaust gas signal 206 reaches a local maximum P2 (see also M1 of FIG. 3). Reaching the local maximum P2 can take place by evaluating the gradient 208 of the exhaust gas signal 206. In particular (see also FIG. 6), the local maximum P2 of the exhaust gas signal 206 can be determined by reaching a zero point of the curve of the gradient 208 of the exhaust gas signal 206 at the time t5, wherein a change from a positive gradient to a negative gradient has to take place at the same time at the zero point. It is thus also possible to preclude that the point P2 is a so-called saddle point (or terrace point), at which the gradient has the same mathematical sign before and after.

If it is thus determined at the time t5 that the exhaust gas signal 206 of the exhaust gas sensor 134 has reached the local maximum P2, the catalytic converter clearing can be ended and the internal combustion engine can change back to normal operation using an essentially stoichiometric combustion gas mixture. The local maximum P2 is preferably the first maximum after the time t_NOx, at which the exhaust gas signal 206 increases during the catalytic converter clearing. Reaching the local maximum P2 states that the exhaust gas signal has reached the unavoidable nitrogen oxide peak and therefore then begins to subside.

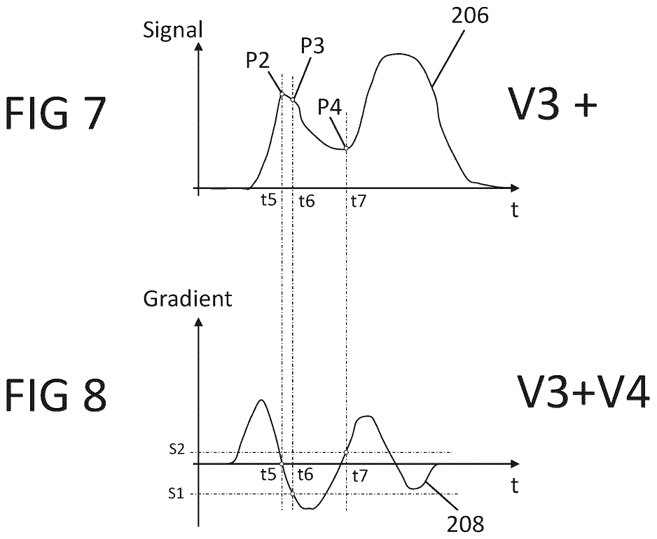

Two further exemplary embodiments are described hereinafter with reference to FIGS. 7 and 8. FIG. 7 again shows the curve of the exhaust gas signal 206 already known from FIGS. 3 and 5 here and FIG. 8 shows the time curve of the gradient 208 of the exhaust gas signal 206 of the exhaust gas sensor 134 already known from FIGS. 4 and 6.

In some embodiments, initially the local maximum P2 can again be determined during the catalytic converter clearing, as already described with respect to FIGS. 5 and 6. In some embodiments, however, the catalytic converter clearing is not terminated upon reaching the local maximum P2, but rather still further exhaust gas signals of the exhaust gas sensor 134 are evaluated thereafter. In particular, in addition the gradient of the exhaust gas signals 206 of the exhaust gas sensor 134 generated after reaching the local maximum P2 are studied and evaluated as to whether these reach a predetermined gradient threshold value S1, S2 (see FIG. 8).

In some embodiments, the catalytic converter clearing can be ended when the gradient of the exhaust gas signal 206, after reaching the local maximum P2, reaches and falls below a predetermined negative gradient threshold value S1 at the time t6. Reaching the negative gradient threshold value S1 indicates that the unavoidable nitrogen oxide peak has been exceeded and the exhaust gas signal thereupon decreases again. An increase of the exhaust gas signal is thereupon to be expected due to the generation of ammonia.

In some embodiments, the catalytic converter clearing can be ended when the gradient of the exhaust gas signal 206, after reaching the local maximum P2, reaches and exceeds a predetermined positive gradient threshold value S2 at the time t7. However, the gradient threshold value S2 can also be predetermined as negative. Moreover, due to the mathematics behind this, this presumes that the exhaust gas signal 206 passes through the local minimum M2 (see FIG. 3) and therefore the gradient of the exhaust gas signal 206 passes through the zero point at the time t2 (see FIG. 4). This means that now the increase of the ammonia emissions outweighs the abatement of the nitrogen oxide emissions.

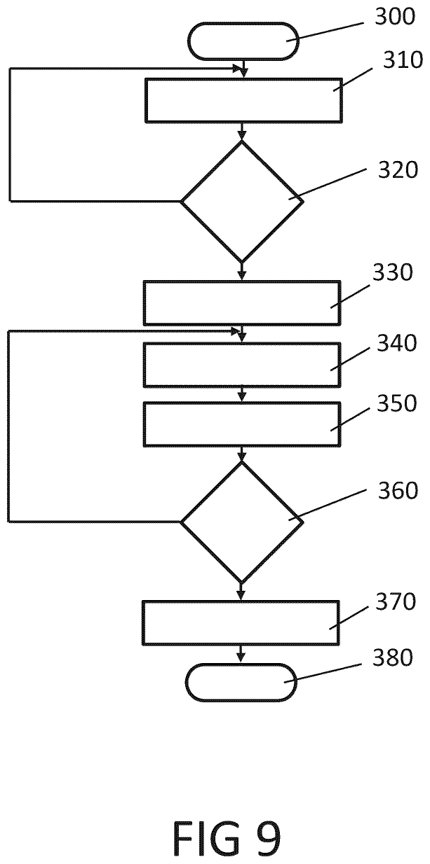

FIG. 9 shows a flow chart of an example method incorporating teachings of the present disclosure for operating the internal combustion engine 100 of FIG. 1.

The method of FIG. 9 starts at step 300 and then goes on to step 310, at which a throttle cut-off phase of the internal combustion engine 100 has been identified. A throttle cut-off phase of the internal combustion engine 100 can be identified, for example, on the basis of the position of the gas pedal and/or on the basis of the speed of the internal combustion engine 100.

In step 320, it is checked whether the internal combustion engine 100 is in the throttle cut-off phase for a sufficiently long time. If it is recognized in step 320 that the predetermined time threshold value (for example, 2 seconds depending on the operating point of the internal combustion engine 100) is not yet reached, the method goes back to step 310.

However, if it is determined in step 320 that the internal combustion engine 100 has already been in the throttle cut-off phase for longer than the predetermined time threshold value, the method goes on to step 330, in which the internal combustion engine 100 is actuated such that it is operated using a rich combustion gas mixture. In particular, it can be presumed when the predetermined time threshold value has passed that the catalytic converter device 132 is completely filled with oxygen, because of which the operation using a rich combustion gas mixture, which is carried out in step 330, is started for reduction of the oxygen. This operation of the internal combustion engine 100 using a rich combustion mixture, which follows the throttle cut-off phase, is referred to as catalytic converter clearing.

In step 340, at least one exhaust gas signal of the exhaust gas Sensor 134 is received.

In step 350, the at least one exhaust gas signal of the exhaust gas sensor 134 received in step 340 is evaluated. In particular, in step 350, the curve of the exhaust gas signal 206 (see FIGS. 5 and 7) and the curves of the gradient 208 (see FIGS. 6 and 8) of the exhaust gas signal 206 are evaluated and checked with regard to achieving predetermined target criteria.

In step 360, it is checked whether a predetermined target criterion is met. If it is determined in step 360, for example, that the predetermined target criterion is not yet met, the method goes back to step 340. However, if it is determined in step 360 that the predetermined target criterion is met, the method goes on to 370, at which the internal combustion engine 100 is switched from the operation using the rich combustion gas mixture to a normal operation using an essentially stoichiometric combustion gas mixture, before the method is ended in step 380.

A target criterion to be met in step 360 can be exceeding or reaching the predetermined exhaust gas threshold value C1 (see also FIG. 5). In some embodiments, the target criterion can be reaching the local maximum P2 (see FIGS. 5 and 6), reaching the predetermined gradient threshold value S1, or reaching the predetermined gradient threshold value S2. The predetermined target criterion can be a predetermined section, e.g. a point, which the exhaust gas signal 206 has to reach in order to meet this.

If none of the mentioned target criteria is met, the catalytic converter clearing is again to be terminated based on the lambda signal of the binary lambda probe and/or based on the known loading model of the catalytic converter device 132.

The method described herein for terminating the catalytic converter clearing after a throttle cut-off phase, can be carried out here upon any sufficiently long throttle cut-off phase. In some embodiments, the method can be used to adapt a model-based catalytic converter clearing strategy in order to minimize any modeling errors over the running time of the internal combustion engine. The model-based catalytic converter clearing strategy is based here on the termination of the catalytic converter clearing when the calculated oxygen loading value, which decreases based on the fuel mass injected in addition to the stoichiometric ratio, falls below a predetermined oxygen loading threshold value. Since this calculation has modeling inaccuracies due to deviations in the input parameters (e.g., measured lambda value, measured exhaust gas mass flow, aging state of the catalytic converter device, which can influence the threshold value, etc.), an adaptation based on the measured nitrogen oxide value would be able to at least largely compensate for this.

The methods described herein may provide the result that pollutant emissions, in particular nitrogen oxide, ammonia, carbon oxide, and/or hydrocarbon emissions, of the internal combustion engine are substantially minimized during the catalytic converter clearing.

What is claimed is:

1-11. (canceled)

12. A method for operating an internal combustion engine having an exhaust gas system with a catalytic converter device to at least partially store oxygen and an exhaust gas sensor downstream from the catalytic converter device to generate an exhaust gas signal representing an exhaust gas value corresponding to a sum of nitrogen oxide content and ammonia content in the exhaust gas, the method comprising:
operating the internal combustion engine using a rich combustion gas mixture after a throttle cut-off phase of the internal combustion engine has taken place longer than a predetermined time threshold value;
receiving an exhaust gas signal from the exhaust gas sensor;
determining that the exhaust gas signal meets a predetermined target criterion; and
operating the internal combustion engine using an essentially stoichiometric combustion gas mixture if the exhaust gas signal meets the predetermined target criterion.

13. The method as claimed in claim 12, wherein determining whether the exhaust gas signal meets the predetermined target criterion comprises determining whether the received exhaust gas signal indicates an exhaust gas value exceeds a predetermined exhaust gas threshold value.

14. The method as claimed in claim 12, wherein determining the exhaust gas signal meets the predetermined target criterion furthermore comprises determining the exhaust gas signal has reached a local maximum.

15. The method as claimed in claim 14, wherein determining the exhaust gas signal meets the predetermined target criterion furthermore comprises:
receiving a further exhaust gas signal after the local maximum has been reached; and
determining that a gradient of the further exhaust gas signal has reached a predetermined gradient threshold value.

16. The method as claimed in claim 15, wherein the gradient threshold value is negative or positive.

17. The method as claimed in claim 12, wherein the essentially stoichiometric combustion gas mixture has a lambda value between 0.998 and 1.002.

18. The method as claimed in claim 12, wherein the rich combustion gas mixture has a lambda value of approximately 0.8.

19. The method as claimed in claim 12, wherein the predetermined time threshold value is between 1 and 5 seconds.

20. A computer-readable tangible storage medium storing a computer program including commands which, when they are executed by a processor or control unit of a controller, cause the controller to:
operate an internal combustion engine using a rich combustion gas mixture after a throttle cut-off phase of the internal combustion engine has taken place longer than a predetermined time threshold value;
receive an exhaust gas signal from an exhaust gas sensor;
determine that the exhaust gas signal meets a predetermined target criterion; and
operate the internal combustion engine using an essentially stoichiometric combustion gas mixture if the exhaust gas signal meets the predetermined target criterion.

21. A controller for an internal combustion engine having an exhaust gas system with a catalytic converter device to store oxygen and an exhaust gas sensor downstream from the catalytic converter device to generate an exhaust gas signal indicating an exhaust gas value corresponding to a sum of nitrogen oxide content and ammonia content in the exhaust gas, the controller programmed to:
operate an internal combustion engine using a rich combustion gas mixture after a throttle cut-off phase of the internal combustion engine has taken place longer than predetermined time threshold value;
receive an exhaust gas signal from an exhaust gas sensor;
determine that the exhaust gas signal meets a predetermined target criterion; and
operate the internal combustion engine using an essentially stoichiometric combustion gas mixture if the exhaust gas signal meets the predetermined target criterion.
